(19) United States
(12) Patent Application Publication
(10) Pub. No.: US 2020/0218005 A1
(43) Pub. Date: Jul. 9, 2020

(54) DISPLAY DEVICE

(71) Applicants: Jeaheon AHN, Hwaseong-si (KR); Cheonjae MAENG, Suwon-si (KR)

(72) Inventors: Jeaheon AHN, Hwaseong-si (KR); Cheonjae MAENG, Suwon-si (KR)

(21) Appl. No.: 16/732,881

(22) Filed: Jan. 2, 2020

(30) Foreign Application Priority Data
Jan. 3, 2019 (KR) 10-2019-0000688

(51) Int. Cl. F21V 8/00

(52) U.S. Cl. CPC G02B 6/0055; G02B 6/005; G02B 6/0068

(57) ABSTRACT

A display device includes a display panel, a first light source emitting a first color light, a light guide member including an incident surface into which the first color light is incident, an opposite surface facing the incident surface in a first direction, and an emission surface facing the display panel and connecting the incident surface and the opposite surface, a light control layer converting the first color light to a light having a color different from the first color to output the converted light to the display panel, and a reflective member including a first reflective area including first openings and a second reflective area including second openings. The first reflective area is disposed closer to the incident surface than the second reflective area, and intervals between two adjacent first openings of the first openings decrease along the first direction toward the opposite surface.

### CROSS-REFERENCE TO RELATED APPLICATION

This application claims priority from and the benefit of Korean Patent Application No. 10-2019-0000688, filed on Jan. 3, 2019, which is hereby incorporated by reference for all purposes as if fully set forth herein.

### BACKGROUND

### Field

Exemplary embodiments of the invention relate generally to a display device, and more specifically, to a display device having an improved brightness.

### Discussion of the Background

A display device having low power consumption, good portability, and high added value has been spotlighted as a next-generation advanced display device. The display device includes a thin film transistor for each pixel to control ON/OFF of the voltage for each pixel.

The display device includes a display panel and a light source to provide a light to the display panel. The light source includes a light emitting element and a light guide member. The light emitted from the light emitting element is incident into the light guide member through an incident surface of the light guide member. The light incident through the incident surface of the light guide member travels to an opposite surface opposing the incident surface by a total reflection. That is, the light generated by the light emitting element is guided in the light guide member and provided to the display panel.

The above information disclosed in this Background section is only for understanding of the background of the inventive concepts, and, therefore, it may contain information that does not constitute prior art.

### SUMMARY

Devices constructed according to exemplary embodiments of the invention are capable of providing a display device having a uniform intensity of light over an entire area of a display panel using a backlight unit.

Additional features of the inventive concepts will be set forth in the description which follows, and in part will be apparent from the description, or may be learned by practice of the inventive concepts.

According to one or more exemplary embodiments of the invention, a display device including a display panel, a first light source emitting a first color light, a light guide member disposed under the display panel and including an incident surface into which the first color light is incident, an opposite surface directly facing the incident surface in a first direction, and an emission surface facing the display panel and connecting the incident surface and the opposite surface, a light control layer disposed between the display panel and the light guide member, the light control layer configured to convert the first color light transmitted from the emission surface to a converted light having a color different from the first color light, and transmit the converted light to the display panel, and a reflective member disposed between the light guide member and the light control layer, the reflective member including a first reflective area including first openings; and a second reflective area including second openings. The first reflective area is disposed closer to the incident surface in a plan view than the second reflective area, and intervals between two adjacent first openings of the first openings in the first direction decrease along the first direction toward the opposite surface.

The display device may further include an adhesive member disposed between the light control layer and the reflective member.

The reflective member may include a metal layer.

The reflective member may further include a first oxide metal layer disposed between the emission surface and the metal layer and a second oxide metal layer disposed between the metal layer and the adhesive member.

A thickness of the metal layer may be greater than the sum of a thickness of the first oxide metal layer and a thickness of the second oxide metal layer.

Intervals between two adjacent second openings of the second openings in the first direction decrease along the first direction toward the opposite surface, and a first interval that is the shortest interval between two adjacent first openings of the first openings may be longer than a second interval that is the longest interval between two adjacent second openings of the second openings.

Intervals between two adjacent second openings of the second openings may be substantially the same to each other in the first direction, and an interval that is the shortest interval between two adjacent first openings of the first openings is longer than intervals between two adjacent second openings of the second openings.

The first openings may include first sub-openings, second sub-openings, and third sub-openings. The first reflective area may include a first sub-reflective area in which the first sub-openings is defined, a second sub-reflective area adjacent to one end of the first sub-reflective area in a second direction substantially perpendicular to the first direction and in which the second sub-openings is defined, and a third sub-reflective area adjacent to the other end of the first sub-reflective area in the second direction and in which the third sub-openings is defined. The first sub-reflective area may be disposed closer to a light emitting element of the first light source in the plan view than the second sub-reflective area and the third sub-reflective area. Intervals between two adjacent second sub-openings of the second sub-openings in the second direction may decrease as a distance from the one end of the first sub-reflective increases, and intervals between two adjacent third sub-openings of the third sub-openings in the second direction decrease as a distance from the other end of the first sub-reflective increases.

Intervals between two adjacent first sub-openings of the first sub-openings in the first direction may decrease as a distance from the light emitting element increases.

The display device may further include a second light source emitting the first color light to the opposite surface. The reflective member may further include a third reflective area disposed adjacent to a side of the first reflective area opposite to the side of the side of the first reflective area adjacent to the second reflective area, the third reflective area including third openings defined in the third reflective area, and intervals between two adjacent third openings of the third openings may decrease along a direction opposite to the first direction.

The second reflective area may include a first central area disposed adjacent to the first reflective area and a second central area disposed adjacent to the third reflective area, intervals between two adjacent second openings in the first central area among the second openings may decrease along the first direction toward the opposite surface, and intervals between two adjacent second openings in the second central area among the second openings may decrease along the direction opposite to the first direction.

The intervals between the two adjacent second openings of the second openings may be substantially the same to each other, and the intervals between the two adjacent second openings of the second openings may be shorter than the intervals between the two adjacent first openings of the first openings and the intervals between the third openings.

The first color light may be a blue color light.

According to one or more exemplary embodiments of the invention, a display device includes: a display panel, a first light source emitting a first color light, a light guide member disposed under the display panel, the light guide member including: an incident surface into which the first color light is incident; an opposite surface facing the incident surface in a first direction; and an emission surface facing the display panel and connected to the incident surface and the opposite surface; a light control layer disposed between the display panel and the light guide member, the light control layer configured to convert the first color light transmitted from the emission surface to a converted light having a color different from the first color light, and transmitting the converted light to the display panel; a first refractive layer disposed between the light guide member and the light control layer, the first refractive layer including openings defined therethrough; and a second refractive layer disposed between the first refractive layer and the light control layer to entirely cover the first refractive layer. The first refractive layer has a first refractive index smaller than a second refractive index of the second refractive layer.

The light guide member may have a refractive index greater than the first refractive index and equal to or smaller than the second refractive index.

Intervals between two adjacent openings of the openings decrease as a distance from one end of the first refractive layer adjacent to the incident surface increases along the first direction.

The light control layer may include a base resin, a first luminant distributed in the base resin to convert the first color light to a second color light, and a second luminant distributed in the base resin to convert the first color light to a third color light.

Each of the openings may be filled with the base resin.

According to one or more exemplary embodiments of the invention, a display device including a first light source emitting a first color light, a light guide member including an incident surface into which the first color light is incident, an opposite surface directly facing the incident surface in a first direction, and an emission surface connected to the incident surface and the opposite surface, refractive patterns spaced apart from each other when viewed in a plan view and disposed on the emission surface, a refractive layer covering the refractive patterns and disposed on the emission surface, a light control layer disposed on the refractive layer, the light control layer configured to convert the first color light exiting from the emission surface to a converted light having a color different from the first color, and a display panel configured to receive the converted light exiting from the light control layer. The light guide member has a refractive index greater than a refractive index of the refractive layer and equal to or smaller than a refractive index of the refractive patterns.

Intervals between two adjacent refractive patterns of the refractive patterns may decrease along a direction in which the incident surface and the opposite surface face each other.

According to the above, the light conversion layer may provide the light emitted from the light source to the display panel at the uniform intensity. As a result, the overall brightness of the display device may increase, and the visibility of the display device may be improved.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a perspective view showing a display device according to an exemplary embodiment of the inventive concepts.

FIG. 2 is an exploded perspective view showing a display device according to an exemplary embodiment of the inventive concepts.

FIG. 3 is a cross-sectional view taken along a sectional line I-I′ shown in FIG. 2.

FIG. 4 is an exploded perspective view showing a backlight unit according to an exemplary embodiment of the inventive concepts.

FIG. 5A is a cross-sectional view taken along a sectional line II-II′ shown in FIG. 4.

FIG. 5B is a cross-sectional view showing a reflective member shown in FIG. 5A according to an exemplary embodiment of the inventive concepts.

FIG. 6 is an enlarged view showing an area AA shown in FIG. 3.

FIG. 7A is a plan view showing a reflective member according to an exemplary embodiment of the inventive concepts.

FIG. 7B is an enlarged view showing an area AA1 shown in FIG. 7A.

FIG. 8A is a plan view showing a reflective member according to another exemplary embodiment of the inventive concepts.

FIG. 8B is an enlarged view showing an area AA2 shown in FIG. 8A according to another exemplary embodiment of the inventive concepts.

FIG. 9A is a plan view showing a reflective member according to another exemplary embodiment of the inventive concepts.

FIG. 9B is a plan view showing a reflective member according to another exemplary embodiment of the inventive concepts.

FIG. 10 is a cross-sectional view taken along the sectional line II-II′ shown in FIG. 4 according to another exemplary embodiment of the inventive concepts.

FIG. 11 is a cross-sectional view taken along the sectional line II-II′ shown in FIG. 4 according to another exemplary embodiment of the inventive concepts.

FIG. 12 is an exploded perspective view showing a backlight unit according to another exemplary embodiment of the inventive concepts.

FIG. 13A is a plan view showing a reflective member shown in FIG. 12 according to an exemplary embodiment of the present disclosure.

FIG. 13B is a plan view showing a reflective member shown in FIG. 12 according to another exemplary embodiment of the inventive concepts.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the DR1-axis, the DR2-axis, and the DR3-axis are not limited to three axes of a rectangular coordinate system, such as the x, y, and z-axes, and may be interpreted in a broader sense. For example, the DR1-axis, the DR2-axis, and the DR3-axis may be perpendicular to one another, or may represent different directions that are not perpendicular one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, the inventive concepts will be explained in detail with reference to the accompanying drawings.

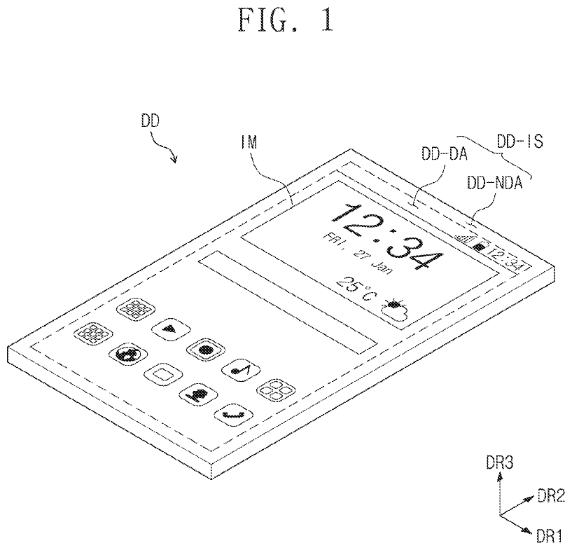

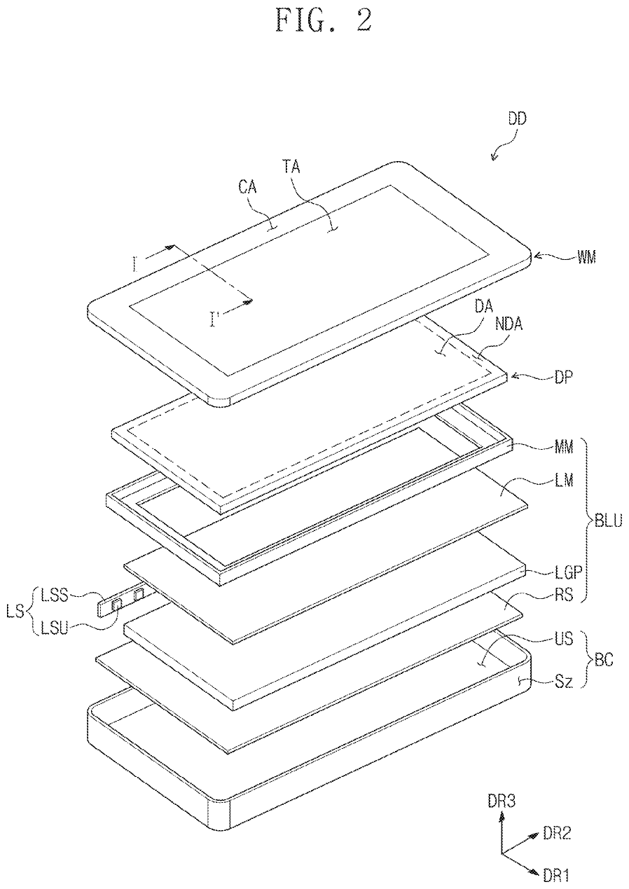

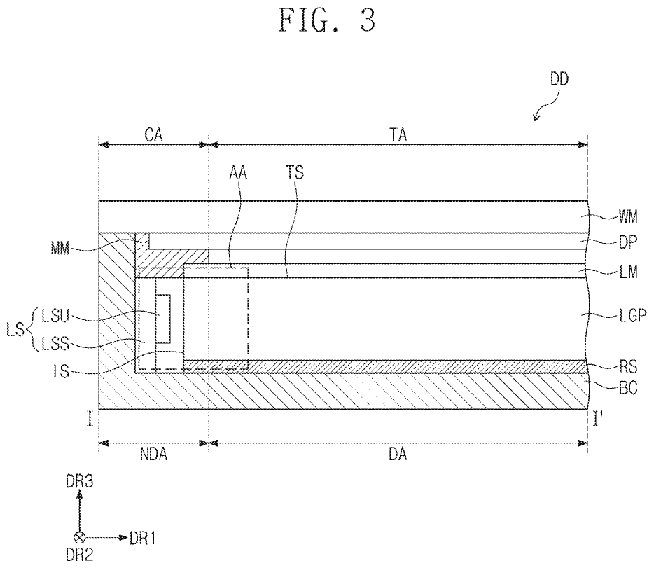

FIG. 1 is a perspective view showing a display device DD according to an exemplary embodiment of the inventive concepts. FIG. 2 is an exploded perspective view showing the display device DD according to an exemplary embodiment of the inventive concepts. FIG. 3 is a cross-sectional view taken along a sectional line I-I′ shown in FIG. 2.

Referring to FIG. 1, the display device DD displays an image IM through a display surface DD-IS. The display surface DD-IS is substantially parallel to a surface defined by a first direction DR1 and a second direction DR2.

A third direction DR3 indicates a direction normal to the display surface DD-IS, i.e., a thickness direction of the display device DD. In the following descriptions, an expression of “when viewed in a plan view” or “in a plan view” may mean “when viewed in the third direction DR3”. Hereinafter, front (or upper) and rear (or lower) surfaces of each layer or each unit of the display device DD are distinct from each other by the third direction DR3. However, directions indicated by the first, second, and third directions DR1, DR2, and DR3 are relative to each other, and thus the directions indicated by the first, second, and third directions DR1, DR2, and DR3 may be changed to other directions.

Meanwhile, the display device DD includes a flat display surface, but it should not be limited thereto or thereby. According to embodiments, the display device DD may include a curved display surface or a three-dimensional display surface. The three-dimensional display surface includes a plurality of display areas facing different directions from each other and includes, for example, a polygonal-column type display surface.

The display device DD according to the inventive concepts may be a rigid display device, however, the display device DD should not be limited to the rigid display device. That is, the display device DD may be a flexible display device. In the present exemplary embodiment, the display device DD applicable to a mobile phone terminal will be described as a representative example. Although not shown in figures, electronic modules mounted on a main board, a camera module, and a power module may be placed in a bracket/case with the display device DD to form the mobile phone terminal. The display device DD according to the inventive concepts may be applied to a large-sized electronic item, such as a television set, a monitor, etc., and a medium and small-sized electronic item, such as a tablet computer, a car navigation unit, a game unit, a smart watch, etc.

The display surface DD-IS includes a display area DD-DA through which the image IM is displayed and a non-display area DD-NDA disposed adjacent to the display area DD-DA. The image IM is not displayed through the non-display area DD-NDA. FIG. 1 shows images of clock windows and icons as a representative example of the image IM.

As shown FIG. 1, the non-display area DD-NDA surrounds the display area DD-DA. However, it should not be limited thereto or thereby, and the shape of the display area DD-DA and the shape of the non-display area DD-NDA may be designed relatively. As an example, the non-display area DD-NDA may be disposed adjacent to only one side of the display area DD-DA or may be omitted.

Referring to FIGS. 2 and 3, the display device DD includes a window member WM, a display panel DP, a backlight unit BLU, and an accommodation member BC.

The window member WM includes a transmission area TA transmitting the image provided from the display panel DP and a light blocking area CA defined adjacent to the transmission area TA, and the light blocking area CA does not transmit the image. The transmission area TA and the light blocking area CA shown in FIG. 2 may respectively correspond to the display area DD-DA and the non-display area DD-NDA of the display device DD shown in FIG. 1.

The transmission area TA is disposed at a center of the display device DD on a plane surface defined by the first direction DR1 and the second direction DR2. The light blocking area CA is disposed adjacent to the transmission area TA and has a frame shape to surround the transmission area TA, however, the inventive concepts should not be limited thereto or thereby. The light blocking area CA may be disposed adjacent to only a portion of the transmission area TA or may be omitted. The window member WM may include glass, sapphire, plastic, or the like.

The display panel DP is disposed under the window member WM. The display panel DP displays the image using the light provided from the backlight unit BLU. That is, the display panel DP may be a light receiving type display panel. As an example, the display panel DP may be a liquid crystal display panel.

When viewed in a plan view, the display panel DP includes a display area DA and a non-display area NDA disposed adjacent to the display area DA. The display area DA and the non-display area NDA shown in FIG. 2 may respectively overlap with the display area DD-DA and the non-display area DD-NDA shown in FIG. 1.

The backlight unit BLU is disposed under the display panel DP to provide the light to the display panel DP. According to the exemplary embodiment, the backlight unit BLU may be an edge type light source disposed adjacent to a side surface of a light guide member LGP.

The backlight unit BLU according to the present exemplary embodiment includes a light source LS, the light guide member LGP, a light conversion layer LM, a reflective plate RS, and a mold frame MM.

The light source LS is disposed to be adjacent to the side surface of the light guide member LGP in the first direction DR1. However, a position of the light source LS should not be limited thereto or thereby. That is, the light source LS may be disposed adjacent to at least one of side surfaces of the light guide member LGP.

The light source LS includes light emitting elements LSU and a circuit board LSS. The light emitting elements LSU generate the light, which is to be provided to the display panel DP, and provides the light to the light guide member LGP.

According to the present exemplary embodiment, the light emitting elements LSU may generate a light having a first color wavelength band. As an example, the first color wavelength band may be within a blue wavelength band equal to or greater than about 400 nm and equal to or smaller than about 500 nm.

The light emitting elements LSU may include a plurality of light emitting diodes (LEDs), each of which is a point light source, however, they should not be limited thereto or thereby. That is, the light emitting elements LSU may include one point light source or may include a plurality of LED groups.

The light emitting elements LSU are mounted on the circuit board LSS. The circuit board LSS is disposed to face one side portion of the light guide member LGP in the first direction DR1 and extends in the second direction DR2.

The circuit board LSS includes a light source controller connected to the light emitting elements LSU. The light source controller analyzes an image, which is to be displayed through the display panel DP, to output a local dimming signal and controls a brightness of the light generated by the light emitting elements LSU in response to the local dimming signal.

The light guide member LGP is disposed under the display panel DP. The light guide member LGP includes a material having a high light transmittance in a visible light region. As an example, the light guide member LGP includes a glass material. As another embodiment, the light guide member LGP may include a transparent polymer resin, such as polymethyl methacrylate (PMMA). According to the exemplary embodiment of the inventive concepts, the light guide member LGP has a refractive index equal to or greater than about 1.4 and equal to or smaller than about 1.55.

The light conversion layer LM is disposed between the display panel DP and the light guide member LGP. A lower surface of the light conversion layer LM makes contact with an upper surface of the light guide member LGP. The light conversion layer LM absorbs the first color light exiting from the light guide member LGP to the display panel DP and outputs a light having a color different from the first color. According to an embodiment, the light conversion layer LM absorbs the first color light having the blue color and outputs a white color light. As a result, the display panel DP receives the white color light exiting from the light conversion layer LM.

The reflective plate RS is disposed under the light guide member LGP. The reflective plate RS reflects the light traveling downward from the light guide member LGP to an upward direction. The reflective plate RS includes a material that reflects the light and entirely overlaps with a lower portion of the light guide member LGP. As an example, the reflective plate RS may include aluminum or silver. As an example, the reflective plate RS may be a reflective sheet.

The mold frame MM is disposed between the display panel DP and the light conversion layer LM. According to the present exemplary embodiment, the mold frame MM has a frame shape. In detail, the mold frame MM is disposed on an upper surface of the light conversion layer LM to correspond to an edge of the light conversion layer LM. In this case, the mold frame MM does not overlap with the display area DA. The display panel DP is disposed on the mold frame MM. The mold frame MM holds the display panel DP and the backlight unit BLU.

The accommodation member BC is disposed at a lowermost position of the display device DD to accommodate the backlight unit BLU. The accommodation member BC includes a bottom portion US and sidewall portions Sz connected to the bottom portion US. The light source LS is disposed on an inner side surface of one of the sidewall portions Sz of the accommodation member BC. The accommodation member BC includes a metal material having rigidity.

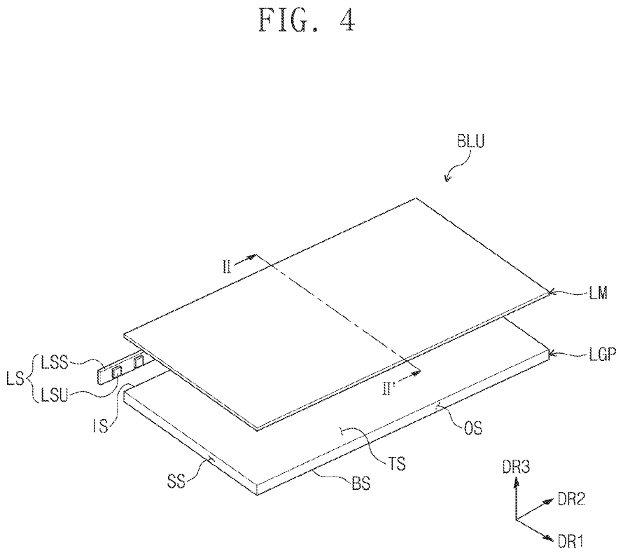

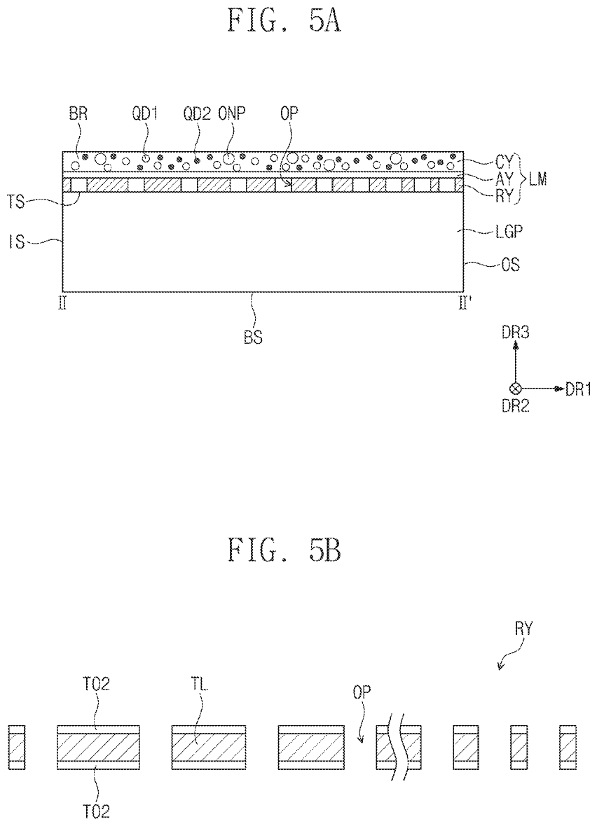

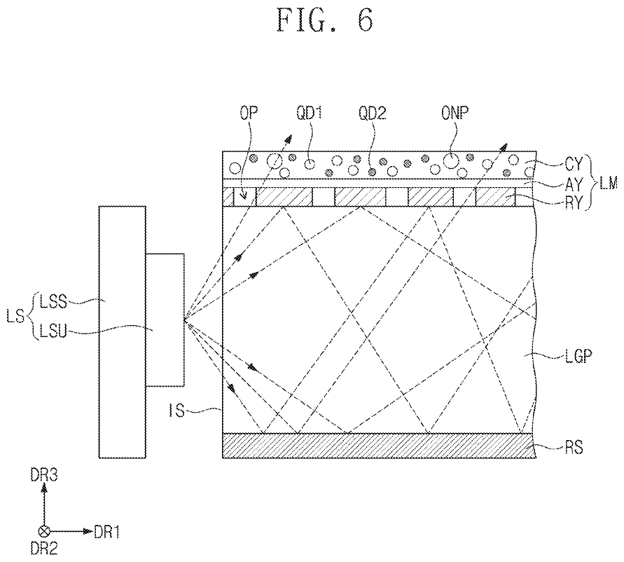

FIG. 4 is an exploded perspective view showing the backlight unit BLU according to an exemplary embodiment of the inventive concepts. FIG. 5A is a cross-sectional view taken along a sectional line II-II′ shown in FIG. 4. FIG. 5B is a cross-sectional view showing a reflective member RY shown in FIG. 5A according to an exemplary embodiment of the inventive concepts. FIG. 6 is an enlarged view showing an area AA shown in FIG. 3.

Referring to FIG. 4, the light guide member LGP includes an emission surface TS, a lower surface BS, and side surfaces IS, SS, and OS connecting the lower surface BS and the emission surface TS. The side surface facing the light source LS among the side surfaces IS, SS, and OS is referred to as an “incident surface” IS, and the side surface facing the incident surface IS in the first direction DR1 among the side surfaces IS, SS, and OS is referred to as an “opposite surface” OS.

Although not shown in figures, the light guide member LGP includes a plurality of light exit patterns formed on the lower surface BS. The light exit patterns refracts or scatters the light incident into the lower surface BS of the light guide member LGP.

As described above, the light source LS outputs the first color light through the incident surface IS of the light guide member LGP. The light incident through the incident surface IS is guided in the light guide member LGP and provided to the light conversion layer LM through the emission surface TS. In particular, an intensity of the light exiting through the emission surface TS adjacent to the incident surface IS is higher than an intensity of the light exiting through the emission surface TS adjacent to the opposite surface OS. That is, the intensity of the light exiting through the emission surface TS becomes weak along the first direction DR1 from the incident surface IS to the opposite surface OS.

According the exemplary embodiment of the inventive concepts, the light conversion layer LM controls the intensity of the light exiting from the emission surface TS so that the light with a uniform intensity is transmitted to the display panel DP.

In detail, referring to FIG. 5A, the light conversion layer LM according to the inventive concepts includes the reflective member RY, an adhesive member AY, and a light control layer CY.

The reflective member RY is disposed on the emission surface TS of the light guide member LGP. As an example, the reflective member RY is directly disposed on the emission surface TS.

According to the exemplary embodiment of the inventive concepts, openings OP is defined through the reflective member RY. When viewed in a plan view, the openings OP defined through the reflective member RY have the same shape and size as each other. The light exiting through the emission surface TS is transmitted to the display panel DP through the openings OP.

In particular, an interval between the openings OP defined through the reflective member RY becomes shorter as a distance from the incident surface IS increases. In other words, the number of the openings OP adjacent to the opposite surface OS is larger than the number of the openings OP adjacent to the incident surface IS. In addition, an area of the reflective member RY adjacent to the incident surface IS is greater than an area of the reflective member RY adjacent to the opposite surface OS.

Accordingly, a first light amount of the light exiting through the openings OP adjacent to the opposite surface OS is larger than a second light amount of the light exiting through the openings OP adjacent to the incident surface IS. As a result, even though the intensity of the light exiting from the emission surface TS adjacent to the opposite surface OS is weaker than the intensity of the light exiting from the emission surface TS adjacent to the incident surface IS, the intensity of the light traveling to the light control layer CY from the reflective member RY may become uniform throughout since the first light amount is larger than the second light amount.

According to the exemplary embodiment of the inventive concepts, the reflective member RY may include a stack structure of a first oxide metal layer TO1, a second oxide metal layer TO2, and a metal layer TL, which are stacked one on another. The reflective member RY may be provided in an integral form. In the present exemplary embodiment, the reflective member RY has a three-stacked-layer structure, however, the inventive concepts should not be limited thereto or thereby. That is, the reflective member RY may have a single-layer structure of the metal layer TL.

The first oxide metal layer TO1 is directly disposed on the emission surface TS, and the second oxide metal layer TO2 is directly disposed on the adhesive member AY. Each of the first and second oxide metal layers TO1 and TO2 is implemented by a transparent conductive layer and protects the metal layer TL from external impacts to improve a reflectance. As an example, the first and second oxide metal layers TO1 and TO2 include at least one of indium tin oxide (ITO), indium zinc oxide (IZO), zinc oxide (ZnO), indium tin zinc oxide (ITZO), PEDOT, metal nano-wire, and graphene.

The metal layer TL is disposed between the first oxide metal layer TO1 and the second oxide metal layer TO2. The metal layer TL has a thickness greater than that of the first oxide metal layer TO1 and the second oxide metal layer TO2. As an example, the metal layer TL includes molybdenum, silver, titanium, copper, aluminum, or an alloy thereof. The metal layer TL reflects the light received thereto from the emission surface TS. That is, the light exiting through the emission surface TS is reflected by the metal layer TL and then is incident into the light guide member LGP again.

As shown in FIG. 6, the light emitted from the light source LS is incident into the light guide member LGP through the incident surface IS. The light incident through the incident surface IS is guided in the light guide member LGP along the first direction DR1.

As an example, some of the light incident through the incident surface IS are transmitted to the reflective member RY disposed on the emission surface TS. In this case, the light transmitted to the reflective member RY through the emission surface TS is reflected by the metal layer TL of the reflective member RY and then travels to the light guide member LGP again.

As an example, some of the light incident through the incident surface IS are transmitted to the reflective plate RS disposed under the light guide member LGP. In this case, the light passing through the lower portion of the light guide member LGP is reflected by the reflective plate RS and then travels to the light guide member LGP again.

Meanwhile, some of the light incident through the incident surface IS are transmitted to the light control layer CY through the openings OP defined through the reflective member RY. Particularly, as described above, the light amount of the light transmitted to the light control layer CY through the openings OP defined through the reflective member RY increases along the first direction DR1.

Referring to FIG. 5A again, the light control layer CY is disposed above the reflective member RY. The light control layer CY has a refractive index higher than a refractive index of the light guide member LGP. As an example, the refractive index of the light control layer CY is equal to or greater than about 1.65.

The light control layer CY converts a wavelength band of the light incident thereto. The light control layer CY according to the exemplary embodiment of the inventive concepts includes a base resin BR and light conversion particles QD1 and QD2 distributed in the base resin BR. Each of the conversion particles QD1 and QD2 absorbs at least a portion of the light incident thereto to emit a light having a specific color or to transmit as it is.

In a case where the incident light into the light control layer CY has an energy enough to excite the conversion particles, the conversion particles absorb at least a portion of the incident light, become excited, and then emit a light of a specific color while being stabilized. Different from the above, in a case where the incident light does not have an energy enough to excite the conversion particles, the incident light passes through the light control layer CY as it is and is viewed from the outside.

In detail, a color of the light emitted from the conversion particles is determined depending on a particle size of the conversion particles. In general, as the particle size increases, the wavelength of the generated light becomes longer, and as the particle size decreases, the wavelength of the generated light becomes shorter.

For example, each of the conversion particles QD1 and QD2 may be a quantum dot. The light emitted from the conversion particles QD1 and QD2 of the light control layer CY may be radiated in various directions.

In detail, the conversion particles include first quantum dots QD1 and second quantum dots QD2. Each of the first quantum dots QD1 absorbs the first color light and converts the first color light to a light having a first conversion color and a second wavelength band. A central wavelength of the second wavelength band is larger than a central wavelength of the first wavelength band. As an example, the second wavelength band is within a range equal to or greater than about 640 nm and equal to or smaller than about 780 nm. That is, each of the first quantum dots QD1 substantially converts the blue light to a red light.

Each of the second quantum dots QD2 absorbs the first color light and converts the first color light to a light having a second conversion color and a third wavelength band. A central wavelength of the third wavelength band is larger than the central wavelength of the first wavelength band and smaller than the central wavelength of the second wavelength band. As an example, the third wavelength band is within a range equal to or greater than about 480 nm and equal to or smaller than about 560 nm. That is, each of the second quantum dots QD2 substantially converts the blue light to a green light.

As described above, the wavelength of the light generated by the conversion particles may be determined depending on the particle size of the conversion particles. According to the present exemplary embodiment, a size of each of the first quantum dots QD1 may be greater than a size of each of the second quantum dots QD2.

In addition, the light control layer CY may further include scatterers ONP. The scatterers ONP may be mixed with the first quantum dots QD1 and the second quantum dots QD2.

The adhesive member AY is disposed between the light control layer CY and the reflective member RY. That is, the light control layer CY and the reflective member RY may be partitioned by the adhesive member AY.

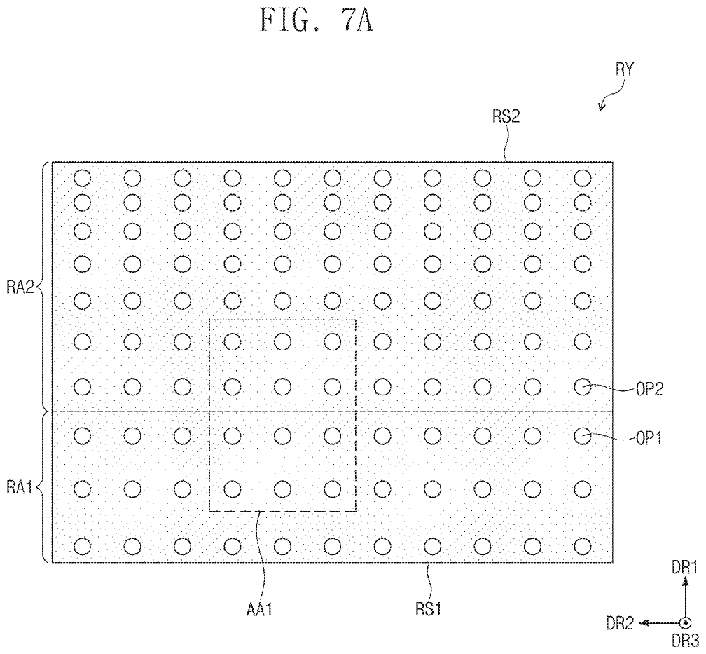

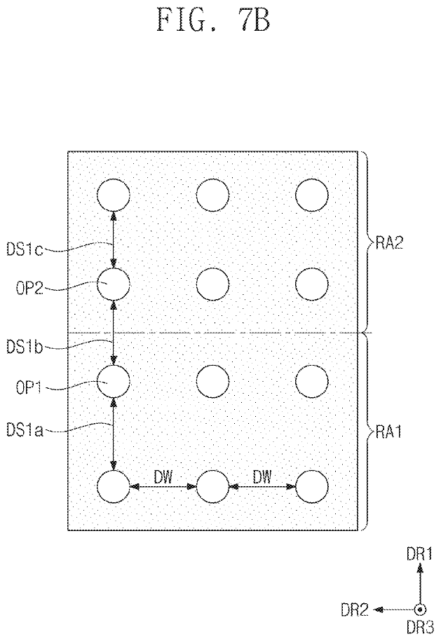

FIG. 7A is a plan view showing the reflective member RY according to an exemplary embodiment of the inventive concepts. FIG. 7B is an enlarged view showing an area AA1 shown in FIG. 7A.

Referring to FIG. 7A, the reflective member RY includes a first reflective area RA1 and a second reflective area RA2. First openings OP1 is defined in the first reflective area RA1, and second openings OP2 is defined in the second reflective area RA2. When viewed in a plan view, the first reflective area RA1 is disposed more adjacent (or closer) to the incident surface IS of the light guide member LGP than the second reflective area RA2. In addition, one end RS1 of the reflective member RY is disposed adjacent to the incident surface IS of the light guide member LGP, and the other end RS2 of the reflective member RY is disposed adjacent to the opposite surface OS of the light guide member LGP.

FIG. 7A shows the first openings OP1 and the second openings OP2, each of which has a circular shape in a plan view, however, the inventive concepts should not be limited thereto or thereby. That is, the shape of the first openings OP1 and the second openings OP2 may be changed in various ways. As an example, the first openings OP1 and the second openings OP2 may have a quadrangular shape or a rhombus shape. Similarly, openings described hereinafter may have various shapes.

According to an exemplary embodiment, an area of the first reflective area RA1 may be smaller than an area of the second reflective area RA2 of the reflective member RY when viewed in a plan view. For instance, a ratio of the first reflective area RA1 to the second reflective area RA2 may be 3:7.

In addition, as described above, intervals between the first openings OP1 and intervals between the second openings OP2 become shorter along the first direction DR1. For example, a first area in a plan view of the reflective member RY spaced apart from the one end RS1 of the reflective member RY by a first distance is greater than a second area in a plan view of the reflective member RY spaced apart from the other end RS2 of the reflective member RY by the first distance. In the present exemplary embodiment, the area of the reflective member means the area obtained by excluding the opening

Accordingly, an amount of the light reflected at the first area after exiting through the emission surface TS of the light guide member LGP is greater than an amount of the light reflected at the second area after exiting through the emission surface TS of the light guide member LGP. In other words, the amount of the light transmitted to the light control layer CY from the area of the reflective member RY adjacent to the opposite surface OS of the light guide member LGP is larger than the amount of the light transmitted to the light control layer CY from the area of the reflective member RY adjacent to the incident surface IS of the light guide member LGP. As a result, even though the intensity of the light exiting from the emission surface TS adjacent to the opposite surface OS is relatively weaker than the intensity of the light exiting from the emission surface TS adjacent to the incident surface IS of the light guide member LGP, the intensity of the light provided to an entire area of the display panel DP may become uniform by the reflective member RY.

As shown in FIG. 7B, the intervals between the first openings OP1 defined in the first reflective area RA1 and the intervals between the second openings OP2 defined in the second reflective area RA2 may be substantially the same as each other, e.g., a first distance DW in the second direction DR2. In addition, the intervals between the second openings OP2 defined in the second reflective area RA2 may be shorter than the intervals between the first openings OP1 defined in the first reflective area RA1.

As an example, the interval between two first openings OP1 adjacent to each other in the first direction DR1 and disposed closest to the second reflective area RA2 is referred to as a “first interval”. That is, the first interval is an interval between two openings adjacent to each other, which is the shortest length in the first direction DR1, among the first openings OP1. The first interval is indicated by a first length DS1a.

As an example, the interval between two second openings OP2 adjacent to each other in the first direction DR1 and disposed closest to the first reflective area RA1 is referred to as a “second interval”. That is, the second interval is an interval between two openings adjacent to each other, which is the longest length in the first direction DR1, among the second openings OP2. The second interval is indicated by a second length DS1c.

As an example, the interval between two openings OP1 and OP2 adjacent to each other in the first direction DR1 with a boundary between the first reflective area RA1 and the second reflective area RA2 interposed therebetween is referred to as a “third interval”. The third interval is indicated by a third length DS1b.

According to the inventive concepts, the first length DS1a is longer than the second length DS1b, and the third length DS1c is longer than the second length DS1b. That is, the intervals between the openings aligned in the same column in the first direction DR1 become shorter along the first direction DR1 from the one end RS1 of the reflective member RY to the other end RS2 of the reflective member RY.

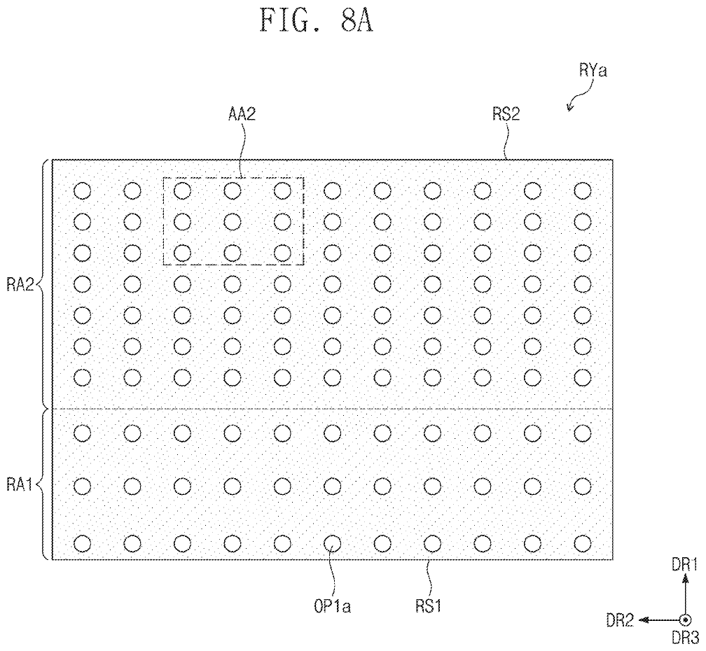

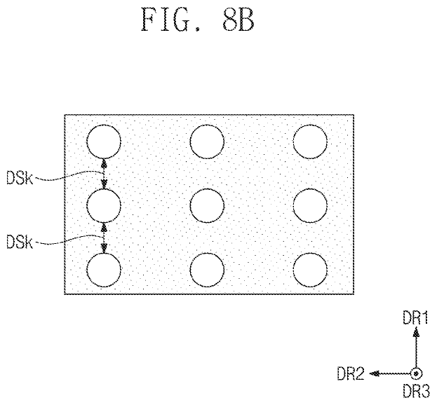

FIG. 8A is a plan view showing a reflective member RYa according to another exemplary embodiment of the inventive concepts. FIG. 8B is an enlarged view showing an area AA2 shown in FIG. 8A according to another exemplary embodiment of the inventive concepts.

When compared with the reflective member RY shown in FIG. 7A, the reflective member RYa shown in FIG. 8A may have substantially the same first reflective area RA1 but a different second reflective area RA2.

Referring to FIGS. 8A and 8B, intervals between first openings OP1a defined in the first reflective area RA1 become shorter along the first direction DR1. That is, the first reflective area RA1 in which the first openings OP1a shown in FIG. 8A are defined may be substantially the same as the first reflective area RA1 in which the first openings OP1 shown in FIG. 7A are defined.

However, different from the embodiment shown in FIG. 7A, intervals between second openings OP2a defined in the second reflective area RA2 in the first direction DR1 shown in FIG. 8A are substantially the same as each other, e.g., a length DSk. However, each of the intervals between the second openings OP2a, which is provided in the same length DSk, may be shorter than an interval between two first openings OP1a adjacent to each other in the first direction DR1 and disposed closest to the second reflective area RA2.

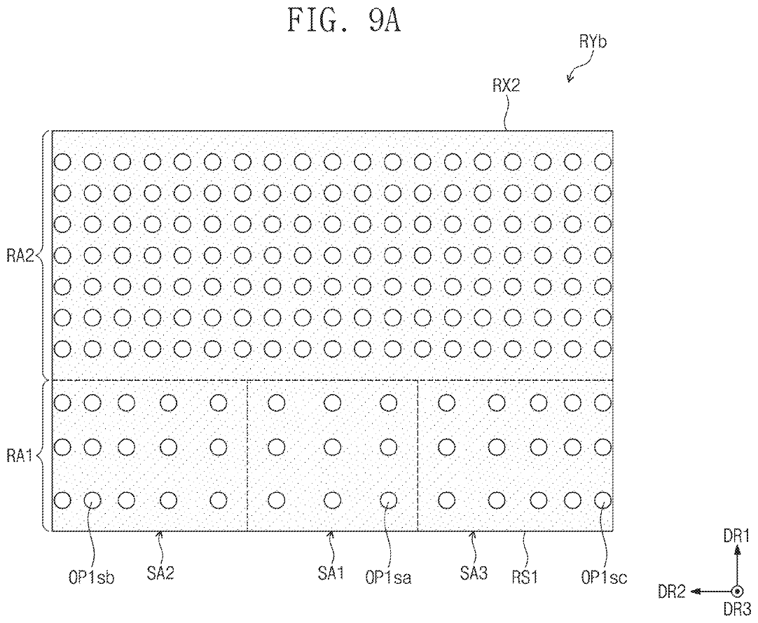

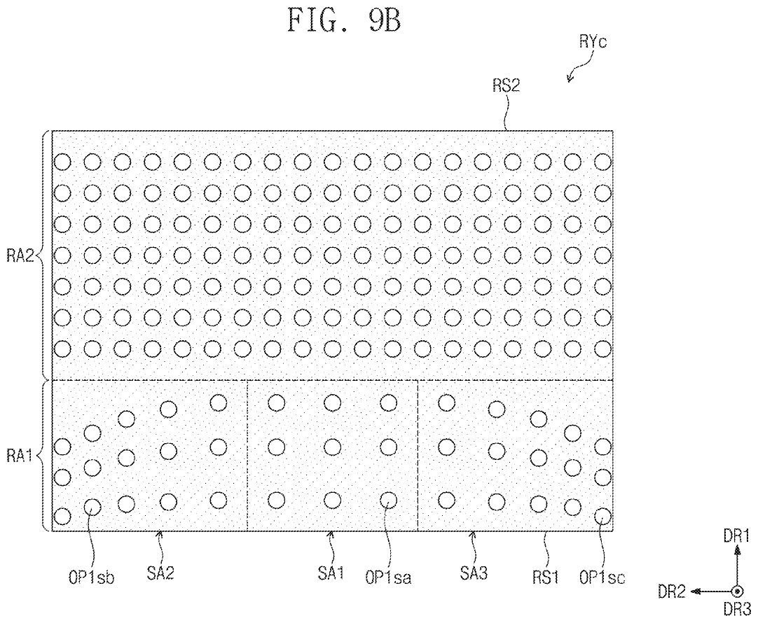

FIG. 9A is a plan view showing a reflective member RYb according to another exemplary embodiment of the inventive concepts. FIG. 9B is a plan view showing a reflective member RYc according to another exemplary embodiment of the inventive concepts.

Referring to FIG. 9A, the first reflective area RA1 includes a first sub-reflective area SA1 in which first sub-opening is defined OP1sa, a second sub-reflective area SA2 in which second sub-opening is defined OP1sb, and a third sub-reflective area SA3 in which third sub-opening is defined OP1sc. The second sub-reflective area SA2 is disposed adjacent to one end of the first sub-reflective SA1 and the third sub-reflective area SA3 is disposed adjacent to the other end of the first sub-reflective.

In particular, the first sub-reflective area SA1 is disposed more adjacent to the light source LS (refer to FIG. 2) than the second sub-reflective area SA2 and the third sub-reflective area SA3.

According to the exemplary embodiment of the inventive concepts, intervals between the first sub-openings OP1sa defined in the first sub-reflective area SA1 become shorter as a distance from the light source unit LSU increases. As an example, the intervals between the first sub-openings OP1sa defined in the first sub-reflective area SA1 become shorter as the distance from the light source unit LSU increases in the first direction DR1. As another example, the intervals between the first sub-openings OP1sa become shorter along the second direction DR2 or a direction opposite to the second direction DR2, however, they should not be limited thereto or thereby. That is, the intervals between the first sub-openings OP1sa may be substantially the same as each other.

According to the exemplary embodiment, intervals between the second sub-openings OP1sb defined in the second sub-reflective area SA2 become shorter as a distance from the light source unit LSU increases. As an example, the intervals between the second sub-openings OP1sb defined in the second sub-reflective area SA2 become shorter as the distance from the light source unit LSU increases along the first direction DR1. As another example, the intervals between the second sub-openings OP1sb become shorter along the direction opposite to the second direction DR2.

According to the exemplary embodiment, intervals between the third sub-openings OP1sc defined in the third sub-reflective area SA3 become shorter as a distance from the light source unit LSU increases. As an example, the intervals between the third sub-openings OP1sc defined in the third sub-reflective area SA3 become shorter as the distance from the light source unit LSU increases along the first direction DR1. As another example, the intervals between the third sub-openings OP1sc become shorter along the second direction DR2.

Accordingly, when viewed in a plan view, an area of the first sub-reflective area SA is greater than an area of the second sub-reflective area SA2 or the third sub-reflective area SA3. In other words, the amount of the light traveling to the display panel DP after passing through the second sub-reflective area SA2 or the third sub-reflective area SA3 is greater as compared with the first sub-reflective area SA1.

A second sub-reflective area SA2 and a third sub-reflective area SA3 shown in FIG. 9B may have different shapes from those of the second sub-reflective area SA2 and the third sub-reflective area SA3 shown in FIG. 9A.

Referring to FIG. 9B, second sub-openings OP1sb defined in the second sub-reflective area SA2 are disposed more adjacent to one end RS1 of the reflective member RYc along the direction opposite to the second direction DR2. In addition, third sub-openings OP1sc defined in the third sub-reflective area SA3 are disposed more adjacent to the one end RS1 of the reflective member RYc along the second direction DR2.

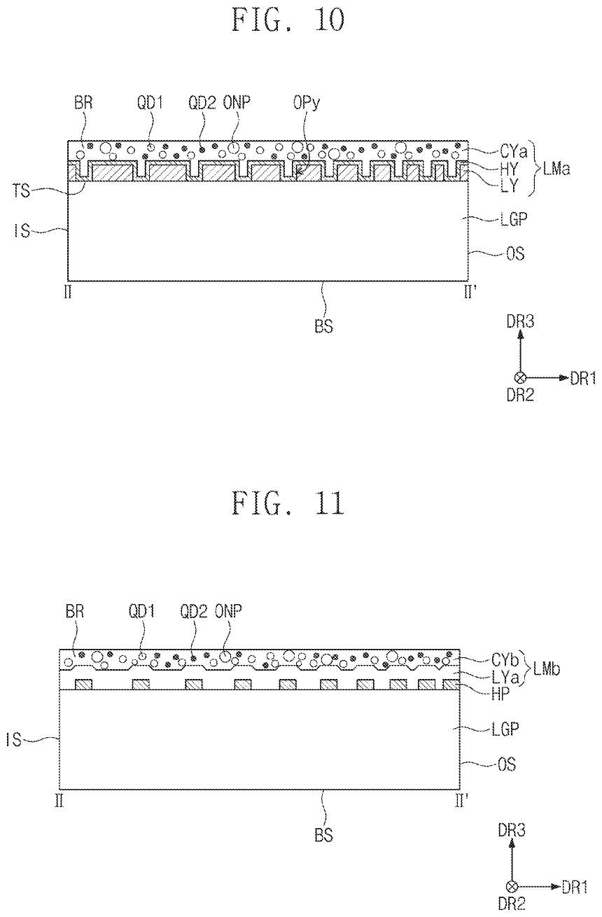

FIG. 10 is a cross-sectional view taken along the sectional line II-II′ shown in FIG. 4 according to another exemplary embodiment of the inventive concepts.

Referring to FIG. 10, a light conversion layer LMa according to the present exemplary embodiment of the inventive concepts includes a first refractive layer LY, a second refractive layer HY, and a light control layer CYa.

The first refractive layer LY (hereinafter, referred to as a “low refractive layer”) is directly disposed on the light guide member LGP. In particular, openings OPy is defined through the low refractive layer LY. According to the exemplary embodiment of the inventive concepts, the low refractive layer LY has a refractive index lower than a refractive index of the light guide member LGP. As an example, the refractive index of the low refractive layer LY is within a range equal to or greater than about 1.1 and equal to or smaller than about 1.3, and the low refractive layer LY has a thickness of about 0.5 micrometers (μm) or more. As described above, the light guide member LGP has the refractive index equal to or greater than about 1.4 and equal to or smaller than about 1.55. That is, the refractive index of the light guide member LGP is greater than the refractive index of the low refractive layer LY.

According to the exemplary embodiment of the inventive concepts, intervals between the openings OPy defined through the low refractive layer LY become shorter along the first direction DR1. The openings OPy defined through the low refractive layer LY are provided in the shape of the first openings OP1 and the second openings OP2 shown in FIG. 7A.

The light incident into the light guide member LGP through the incident surface IS is totally reflected at an interface between the low refractive layer LY and the light guide member LGP by a difference in refractive index between the low refractive layer LY and the light guide member LGP. That is, the light incident into the light guide member LGP through the incident surface IS is transmitted to the opposite surface OS of the light guide member LGP by the total reflection.

In addition, the light incident into the light guide member LGP through the incident surface IS is transmitted to the light control layer CYa through the openings OPy defined through the low refractive layer LY. According to the exemplary embodiment, a first light amount of the light exiting through the openings OPy adjacent to the opposite surface OS is greater than a second light amount of the light exiting through the openings OPy adjacent to the incident surface IS. As a result, even though the intensity of the light exiting from the emission surface TS adjacent to the incident surface IS is stronger than the intensity of the light exiting from the emission surface TS adjacent to the opposite surface OS, the intensity of the light traveling to the light control layer CYa may become uniform throughout since the first light amount is greater than the second light amount. Accordingly, a uniform white light may be provided to the display panel DP in overall.

The second refractive layer HY (hereinafter, referred to as a “high refractive layer”) is disposed on the light guide member LGP to entirely cover the low refractive layer LY. That is, the high refractive layer HY entirely overlaps with the low refractive layer LY and the openings OPy and separates the low refractive layer LY and the light control layer CYa. As shown in FIG. 10, the high refractive layer HY covers the openings OPy and is directly disposed on the light guide member LGP. According to the exemplary embodiment of the inventive concepts, the high refractive layer HY has a refractive index equal to or greater than the refractive index of the light guide member LGP. As an example, the high refractive layer HY has a refractive index equal to or greater than about 1.65.

Since the refractive index of the high refractive layer HY is greater than the refractive index of the low refractive layer LY, the light transmitted to the openings OPy is not totally reflected at the interface between the low refractive layer LY and the high refractive layer HY. That is, the light transmitted to the openings OPy is transmitted to the light control layer CYa after passing through the high refractive layer HY.

In addition, the light control layer CYa has a refractive index greater than that of the light guide member LGP. As an example, the light control layer CYa has the refractive index equal to or greater than about 1.65. For instance, the light control layer CYa shown in FIG. 10 may have substantially the same structure as the light control layer CY shown in FIG. 5A. That is, the light control layer CYa shown in FIG. 10 may have substantially the same structure as the light control layer CY shown in FIG. 5A except for a structure in which the openings OPy defined through the low refractive layer LY are filled with the base resin BR included in the light control layer CYa.

FIG. 11 is a cross-sectional view taken along the sectional line II-II′ shown in FIG. 4 according to another exemplary embodiment of the inventive concepts.

Referring to FIG. 11, a light conversion layer LMb includes high refractive patterns HP, a low refractive layer LYa, and a light control layer CYb.

The high refractive patterns HP are spaced apart from each other when viewed in a plan view and directly disposed on the light guide member LGP. According to the exemplary embodiment, intervals between the high refractive patterns HP become shorter along the first direction DR1.

The high refractive patterns HP have a refractive index greater than a refractive index of the light guide member LGP. As an example, the high refractive patterns HP have the refractive index equal to or greater than about 1.65.

The low refractive layer LYa entirely covers the high refractive patterns HP and is directly disposed on the light guide member LGP. For example, the low refractive layer LYa has a refractive index smaller than that of the light guide member LGP. As an example, the low refractive layer LYa has the refractive index equal to or greater than about 1.1 and equal to or smaller than about 1.3.

As a result, a light transmitted to the high refractive patterns HP among the light transmitted to the emission surface TS is transmitted to the light control layer CYb. The light transmitted to the low refractive layer LYa is guided to the light guide member LGP after being totally reflected.

The light control layer CYb is disposed on the low refractive layer LYa.

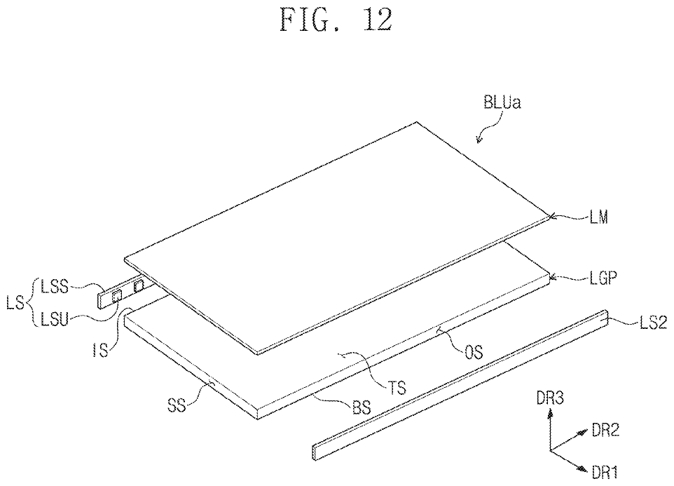

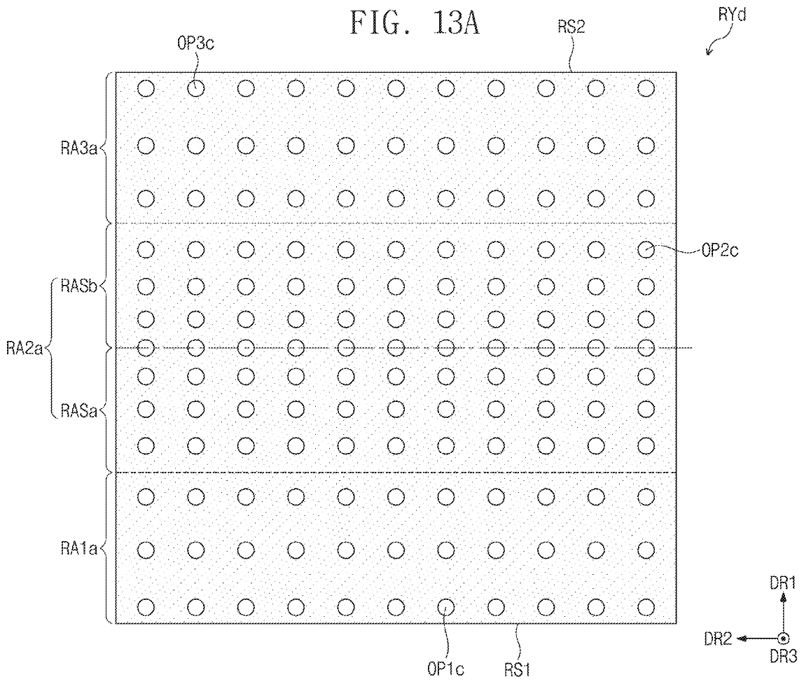

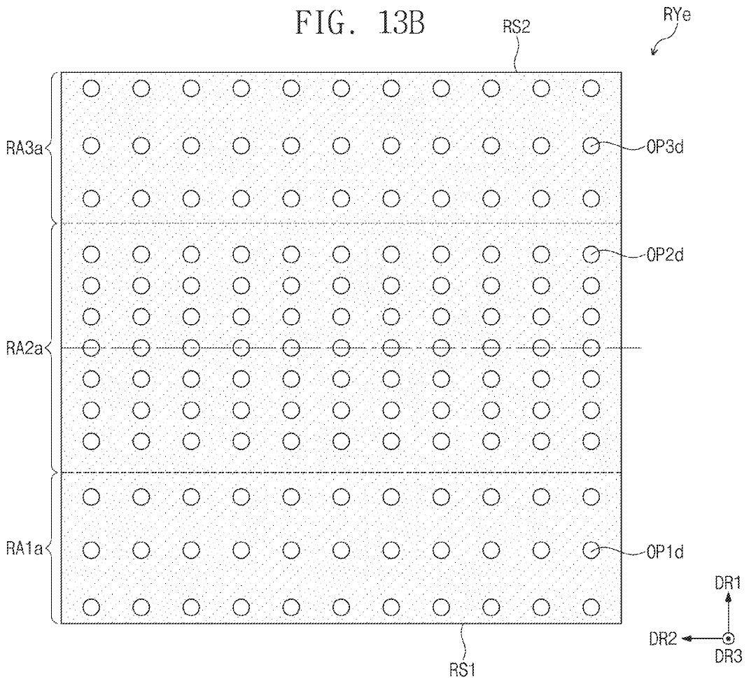

FIG. 12 is an exploded perspective view showing a backlight unit BLUa according to another exemplary embodiment of the inventive concepts. FIG. 13A is a plan view showing a reflective member RYd shown in FIG. 12 according to an exemplary embodiment of the inventive concepts. FIG. 13B is a plan view showing a reflective member RYe shown in FIG. 12 according to another exemplary embodiment of the inventive concepts.

The backlight unit BLUa shown in FIG. 12 may have substantially the same structure as the backlight unit BLU shown in FIG. 2 except that the backlight unit BLUa further includes a second light source LS2. Accordingly, for the convenience of explanation, detailed descriptions on other components will be omitted.

Referring to FIG. 12, the backlight unit BLUa includes the first light source LS1 and the second light source LS2, which face each other in the first direction DR1 with a light guide member LGP interposed therebetween. The first light source LS1 is disposed adjacent to one end of the light guide member LGP, and the second light source LS2 is disposed adjacent to the other end of the light guide member LGP, which faces the one end of the light guide member LGP.

According to the exemplary embodiment of the inventive concepts, each of the first light source LS1 and the second light source LS2 emits a first color (e.g., blue) light to the light guide member LGP.

Referring to FIG. 13A, the reflective member RYd includes a first reflective area RA1a, a second reflective area RA2a, and a third reflective area RA3a. One end RS1 of the reflective member RYd corresponds to an edge of the first reflective area RA1a and is disposed adjacent to an incident surface IS of the light guide member LGP. The other end RS2 of the reflective member RYd corresponds to an edge of the third reflective area RA3a and is disposed adjacent to an opposite surface OS of the light guide member LGP.

First openings OP1c is defined in the first reflective area RA1a, second openings OP2c is defined in the second reflective area RA2a, and third openings OP3c is defined in the third reflective area RA3a.

According to the exemplary embodiment of the inventive concepts, intervals between the first openings OP1c defined in the first reflective area RA1a become shorter along the first direction DR1. On the contrary, intervals between the third openings OP3c defined in the third reflective area RA3a become shorter along a direction opposite to the first direction DR1.

According to the exemplary embodiment of the inventive concepts, the second reflective area RA2a includes a first central area RAsa and a second central area RAsb. Intervals between the second openings OP2c defined in the first central area RAsa become shorter along the first direction DR1, and intervals between the second openings OP2c defined in the second central area RAsb become shorter along the direction opposite to the first direction DR1. The first central area RAsa is disposed between the first reflective area RA1a and the second central area RAsb, and the second central area RAsb is disposed between the first central area RAsa and the third reflective area RA3a.

According to the reflective member RYe shown in FIG. 13B, intervals between second openings OP2d defined in a second reflective area RA2a are substantially the same as each other. In particular, the intervals between the second openings OP2d are shorter than intervals between first openings OP1d and intervals between third openings OP3d.

Although the exemplary embodiments of the inventive concepts have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device comprising:
a display panel;
a first light source emitting a first color light;
a light guide member disposed under the display panel, the light guide member comprising:
an incident surface, into which the first color light is incident;
an opposite surface directly facing the incident surface in a first direction; and
an emission surface facing the display panel and connecting the incident surface and the opposite surface;
a light control layer disposed between the display panel and the light guide member, the light control layer configured to convert the first color light transmitted from the emission surface to a converted light having a color different from the first color light, and transmit the converted light to the display panel; and
a reflective member disposed between the light guide member and the light control layer, the reflective member comprising:
a first reflective area comprising first openings; and
a second reflective area comprising second openings,
wherein the first reflective area is disposed closer to the incident surface in a plan view than the second reflective area, and
wherein intervals between two adjacent first openings of the first openings in the first direction decrease along the first direction toward the opposite surface.

2. The display device of claim 1, further comprising an adhesive member disposed between the light control layer and the reflective member.

3. The display device of claim 2, wherein the reflective member comprises a metal layer.

4. The display device of claim 3, wherein the reflective member further comprises:
a first oxide metal layer disposed between the emission surface and the metal layer; and
a second oxide metal layer disposed between the metal layer and the adhesive member.

5. The display device of claim 4, wherein a thickness of the metal layer is greater than a sum of a thickness of the first oxide metal layer and a thickness of the second oxide metal layer.

6. The display device of claim 1, wherein intervals between two adjacent second openings of the second openings in the first direction decrease along the first direction toward the opposite surface, and
wherein a first interval that is a shortest interval between two adjacent first openings of the first openings is longer than a second interval that is a longest interval between two adjacent second openings of the second openings.

7. The display device of claim 1, wherein intervals between two adjacent second openings of the second openings are substantially the same to each other in the first direction, and
wherein an interval that is a shortest interval between two adjacent first openings of the first openings is longer than intervals between two adjacent second openings of the second openings.

8. The display device of claim 1, wherein the first openings comprises first sub-openings, second sub-openings, and third sub-openings,
wherein the first reflective area comprises:
a first sub-reflective area in which the first sub-openings is defined;
a second sub-reflective area adjacent to one end of the first sub-reflective area in a second direction substantially perpendicular to the first direction and in which the second sub-openings is defined; and
a third sub-reflective area adjacent to the other end of the first sub-reflective area in the second direction and in which the third sub-openings is defined,
wherein the first sub-reflective area is disposed closer to a light emitting element of the first light source in the plan view than the second sub-reflective area and the third sub-reflective area, and
wherein intervals between two adjacent second sub-openings of the second sub-openings in the second direction decrease as a distance from the one end of the first sub-reflective area increases, and
wherein intervals between two adjacent third sub-openings of the third sub-openings in the second direction decrease as a distance from the other end of the first sub-reflective area increases.

9. The display device of claim 8, wherein intervals between two adjacent first sub-openings of the first sub-openings in the first direction decrease as a distance from the light emitting element increases.

10. The display device of claim 1, further including a second light source emitting the first color light to the opposite surface, and
wherein the reflective member further includes: a third reflective area disposed adjacent to a side of the first reflective area opposite to the side of the first reflective area adjacent to the second reflective area, the third reflective area comprising third openings defined in the third reflective area, and
wherein intervals between two adjacent third openings of the third openings decrease along a direction opposite to the first direction.

11. The display device of claim 10, wherein the second reflective area comprises:
a first central area disposed adjacent to the first reflective area; and
a second central area disposed adjacent to the third reflective area;
wherein intervals between two adjacent second openings in the first central area among the second openings decrease along the first direction toward the opposite surface, and intervals between two adjacent second openings in the second central area among the second openings decrease along the direction opposite to the first direction.

12. The display device of claim 10, wherein the intervals between the two adjacent second openings of the second openings are substantially the same to each other, and
wherein the intervals between the two adjacent second openings of the second openings are shorter than the intervals between the two adjacent first openings of the first openings and the intervals between the third openings.

13. The display device of claim 1, wherein the first color light is a blue color light.

14. A display device comprising:
a display panel;
a first light source emitting a first color light;
a light guide member disposed under the display panel, the light guide member comprising:
an incident surface into which the first color light is incident;
an opposite surface facing the incident surface in a first direction; and
an emission surface facing the display panel and connected to the incident surface and the opposite surface;
a light control layer disposed between the display panel and the light guide member, the light control layer configured to convert the first color light transmitted from the emission surface to a converted light having a color different from the first color light, and transmitting the converted light to the display panel;
a first refractive layer disposed between the light guide member and the light control layer, the first refractive layer comprising openings defined therethrough; and
a second refractive layer disposed between the first refractive layer and the light control layer to entirely cover the first refractive layer,
wherein the first refractive layer has a first refractive index smaller than a second refractive index of the second refractive layer.

15. The display device of claim 14, wherein the light guide member has a refractive index greater than the first refractive index and equal to or smaller than the second refractive index.

16. The display device of claim 14, wherein intervals between two adjacent openings of the openings decrease as a distance from one end of the first refractive layer adjacent to the incident surface increases along the first direction.

17. The display device of claim 14, wherein the light control layer comprises:
a base resin;
a first luminant distributed in the base resin to convert the first color light to a second color light; and
a second luminant distributed in the base resin to convert the first color light to a third color light.

18. The display device of claim 17, wherein each of the openings is filled with the base resin.

19. A display device comprising:
a first light source emitting a first color light;
a light guide member comprising an incident surface into which the first color light is incident, an opposite surface directly facing the incident surface in a first direction, and an emission surface connected to the incident surface and the opposite surface;
refractive patterns spaced apart from each other when viewed in a plan view and disposed on the emission surface;
a refractive layer covering the refractive patterns and disposed on the emission surface;
a light control layer disposed on the refractive layer, the light control layer configured to convert the first color light exiting from the emission surface to a converted light having a color different from the first color; and
a display panel configured to receive the converted light exiting from the light control layer,
wherein the light guide member has a refractive index greater than a refractive index of the refractive layer and equal to or smaller than a refractive index of the refractive patterns.

20. The display device of claim 19, wherein intervals between two adjacent refractive patterns of the refractive patterns decrease along a direction in which the incident surface and an opposite surface face each other.
